(19) United States
(12) Patent Application Publication
(10) Pub. No.: US 2016/0107301 A1
(43) Pub. Date: Apr. 21, 2016

(54) Self-Cushioning Hammer

(71) Applicant: Hsiu-Hua Chang, TAICHUNG (TW)

(72) Inventor: Hsiu-Hua Chang, TAICHUNG (TW)

(21) Appl. No.: 14/516,473

(22) Filed: Oct. 16, 2014

(51) Int. Cl. B25D 1/12

(52) U.S. Cl. CPC B25D 1/12

(57) ABSTRACT

A self-cushioning hammer includes a handle, a head formed at an end of the handle, and a cushioning mechanism formed on the handle. The handle includes a front edge, a rear edge, and a centerline extending between the front and rear edges. The includes at least one cutout cut in one of the front and rear edges of the handle.

### BACKGROUND OF INVENTION

1. Field of Invention

The present invention relates to a striking tool and, more particularly, to a self-cushioning hammer.

2. Related Prior Art

A hammer includes a handle, a head attached to an end of the handle and a grip connected to another end of the handle. The head extends substantially perpendicular to the handle. A user holds the hammer by the grip. Then, the user swings the hammer to drive a nail into a piece of wood or concrete with the head. Some energy is transferred into the nail from the head of the hammer. Some other energy is transformed into heat and sound and then dissipated. Still some other energy is inevitably transferred into and absorbed by the user so that the user feels numb in his or her hand.

As disclosed in Taiwanese Patent M457615, a hammer is equipped with a cushion. However, the inclusion of the cushion adds to the cost of the hammer.

Therefore, the present invention is intended to obviate or at least alleviate the problems encountered in prior art.

### SUMMARY OF INVENTION

It is the primary objective of the present invention to provide a self-cushioning hammer.

To achieve the foregoing objective, the self-cushioning hammer includes a handle, a head formed at an end of the handle, and a cushioning mechanism formed on the handle. The handle includes a front edge, a rear edge, and a centerline extending between the front and rear edges. The includes at least one cutout cut in one of the front and rear edges of the handle.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a self-cushioning hammer according to the first embodiment of the present invention;

FIG. 2 is a partial side view of the self-cushioning hammer shown in FIG. 1;

FIG. 3 is a cross-sectional view of the self-cushioning hammer taken along a line A-A shown in FIG. 2;

FIG. 4 is a side view of a nail driven into a piece of wood by the self-cushioning hammer shown in FIG. 1;

FIG. 5 is a partial side view of a self-cushioning hammer according to the first embodiment of the present invention; and

FIG. 6 is a cross-sectional view of the self-cushioning hammer taken along a line B-B shown in FIG. 5.

### DETAILED DESCRIPTION OF EMBODIMENTS

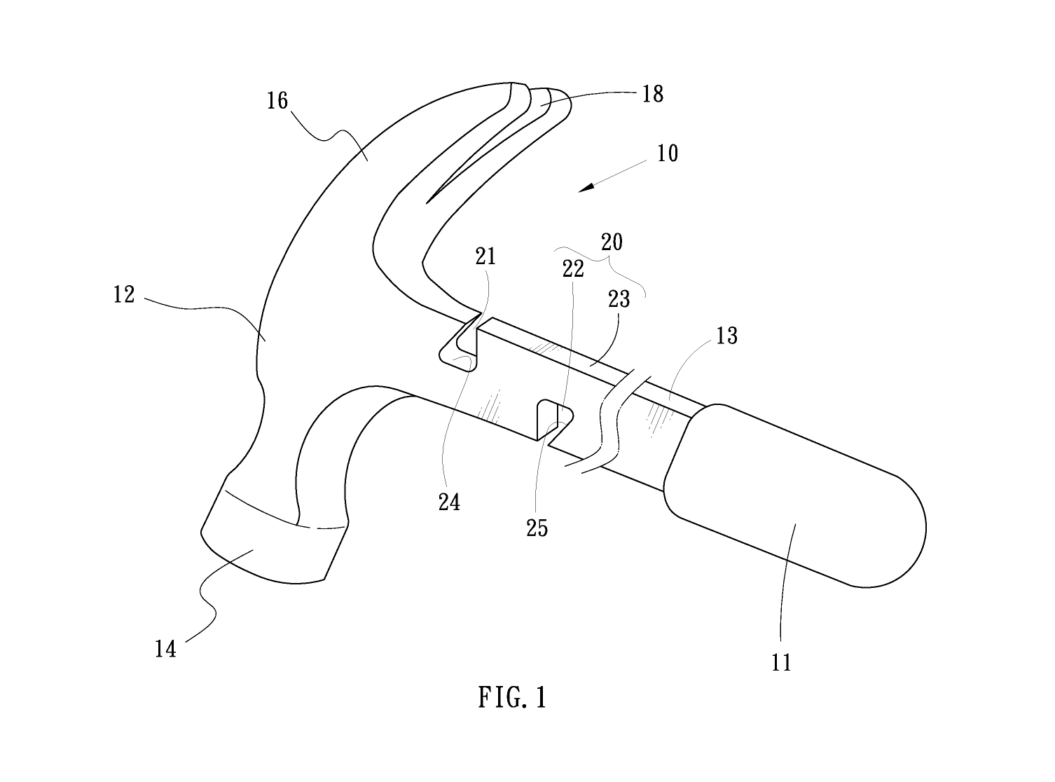

Referring to FIGS. 1 through 4, a self-cushioning hammer 10 includes a handle 13, a head 12 formed at or connected to an end of the handle 13, a grip 11 attached to another end of the handle 13, and a cushioning mechanism 20 made in the handle 13 according to a first embodiment of the present invention. The head 12 includes a bell 14 and a claw 16. The claw 16 includes a slit 18. The handle 13 extends along a phantom centerline L.

The cushioning mechanism 20 includes at least one cutout 22 cut into the handle 13. There are preferably two cutouts 22 and two connective portions 23. One of the cutouts 22 is cut in a front edge of the handle 13, and the other cutout 22 cut in a rear edge of the handle 13. Each of the connective portions 23 is located next to a corresponding one of the cutouts 22.

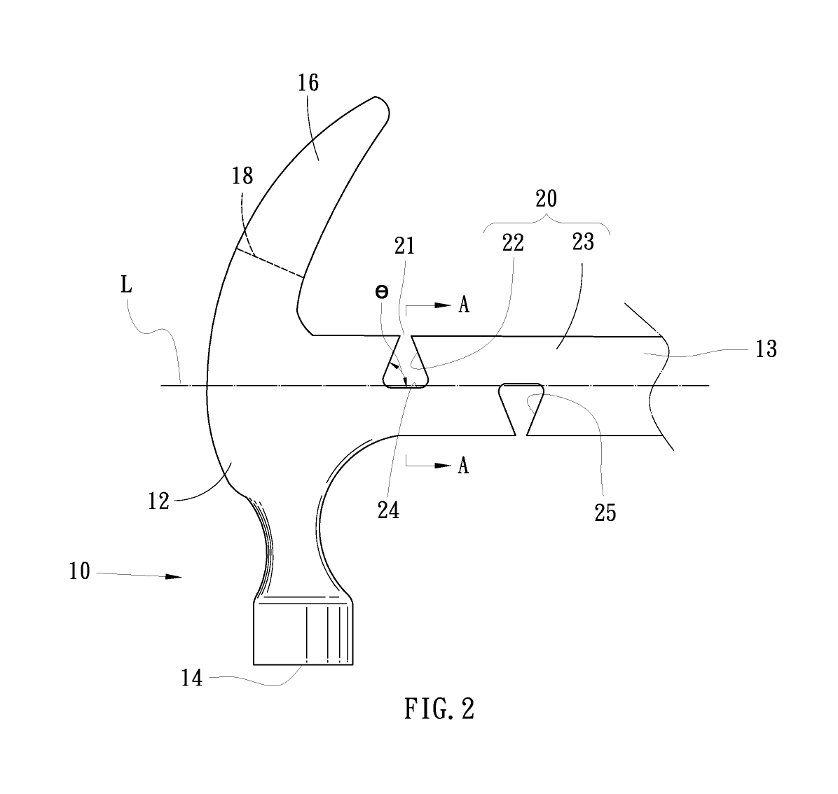

Referring to FIG. 2, each of the cutouts 22 includes an open end 21, a closed end 24, and two walls 25 extending between the open end 21 and the closed end 24. The closed end 24 is a flat face as shown. The closed end 24 is separated from each of the walls 25 by an acute angle θ that is preferably 40° to 80°. However, the closed end 24 can be an arched face in another embodiment. The open end 21 is narrower than the closed end 24, i.e., the walls 25 do not extend parallel to each other.

One of the cutouts 22 is located closer to the head 12 than the other. The cutout 22 located closer to the head 12 will be referred to as the “first cutout 22” and the other cutout 22 will be referred to as the “second cutout 22” for the convenience of the description.

The open end 21 of the first cutout 22 is located at the rear edge of the handle 13 while the closed end 24 of the same is located beyond the centerline L. The open end 21 of the second cutout 22 is located at the front edge of the handle 13 while the closed end 24 of the same is located beyond the centerline L.

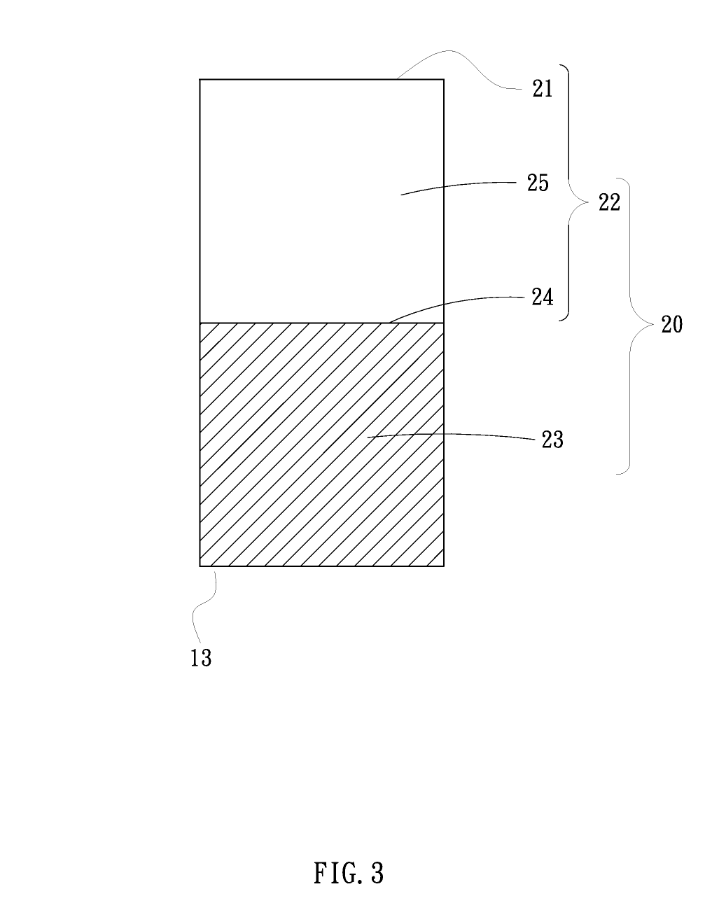

Referring to FIG. 3, the depth of each of the cutouts 22 is larger than the thickness of the corresponding connective portion 23 of the handle 13. The thickness of the connective portions 23 is smaller than the thickness of the other portion of the handle 13.

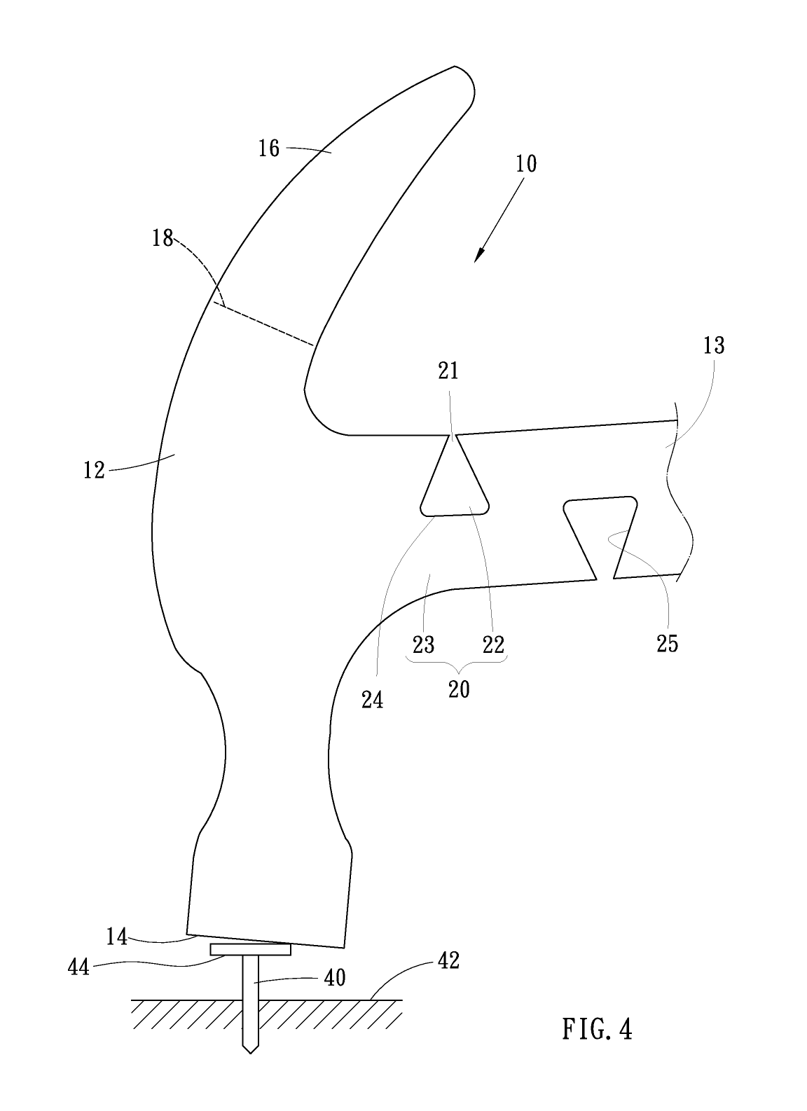

Referring to FIG. 4, a nail 40 is driven into a piece of wood 42 by the hammer 10. The nail 40 is made with a head 44. The head 44 of the nail 40 is in contact with the head 12 of the hammer 10. On this moment, the open end 21 of the first cutout 22 is reduced while the open end 21 of the second cutout 22 is enlarged. That is, considerable temporary deformation of the end of the handle 13 located in the vicinity of the head 12 of the hammer 10 is allowed. Thus, the hammer 10 is cushioned by the cushioning mechanism 20.

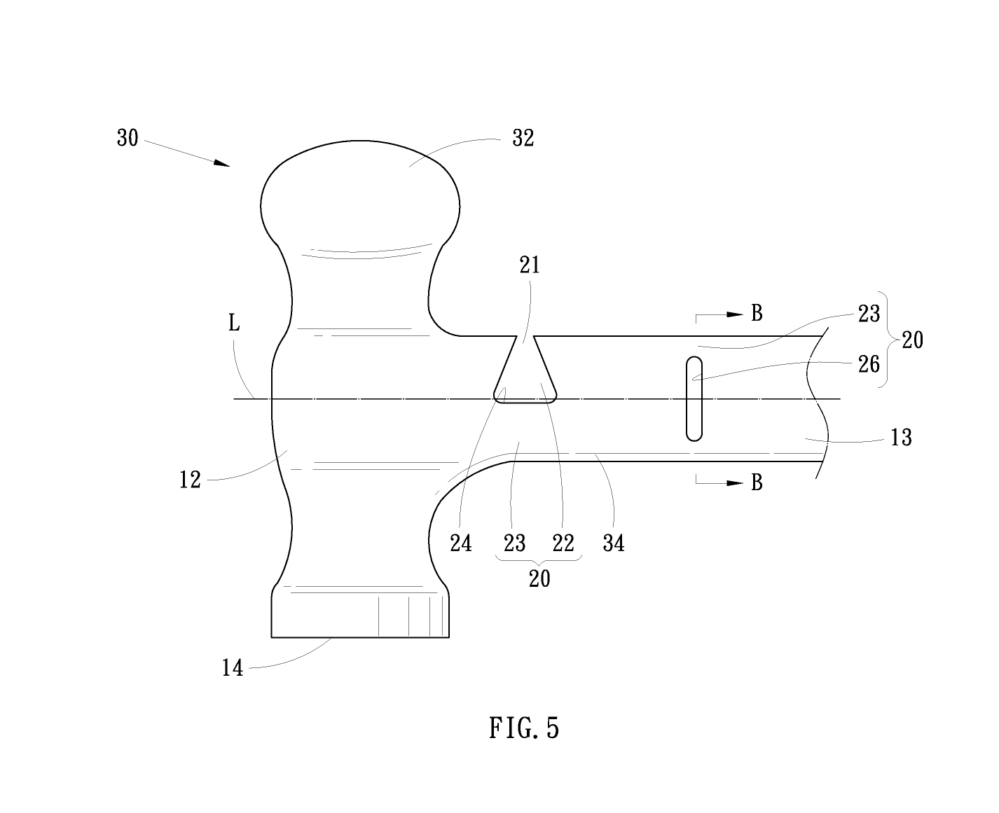

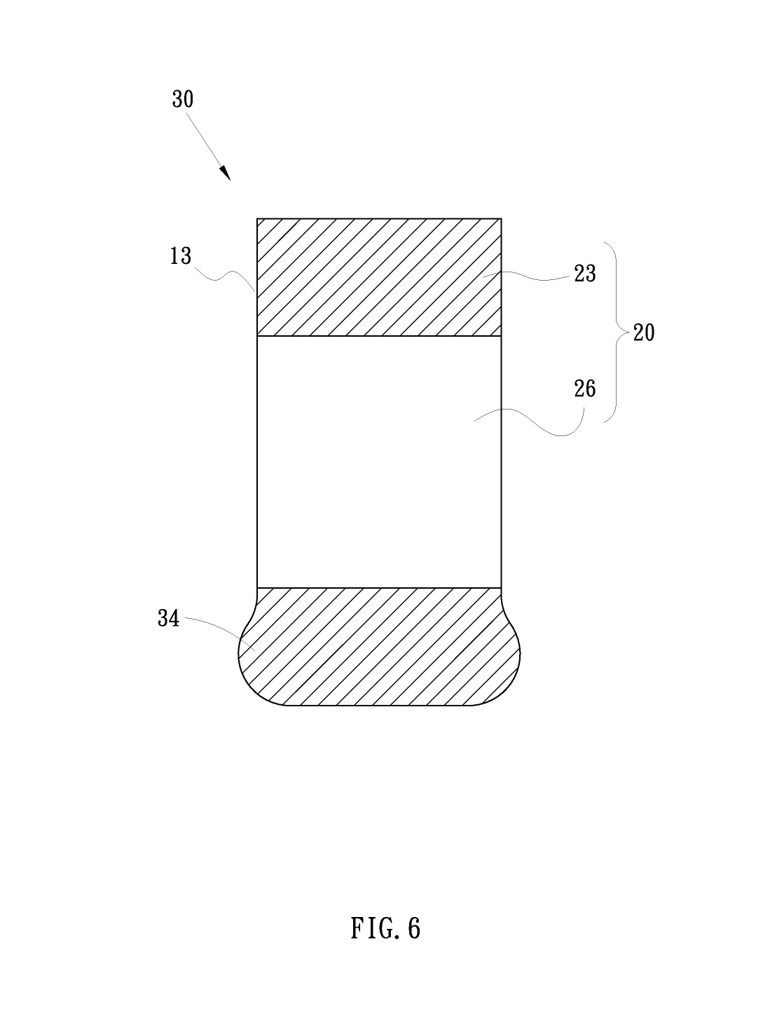

Referring to FIGS. 5 and 6, there is a self-cushioning hammer 30 in accordance with a second embodiment of the present invention. The hammer 30 is like the hammer 10 except for several things. Firstly, the head 12 of the hammer 30 includes a peen 32 instead of the claw 16. Secondly, the cushioning mechanism 20 includes a cutout 22 cut in the rear edge and an aperture 26 made between the rear and front edges. The aperture 26 is preferably in the form of a slot with two closed ends. There is a connective portion 23 among the rear edge of the handle 13 and another connective portion 34 among the front edge of the handle 13. The length of the aperture 26, measured from one of the closed ends to the other closed end, is larger than the sum of the thickness of the connective portion 23 and the thickness of the connective portion 34. The aperture 26 can be in the form of a circular aperture of a diameter larger than the sum of the thickness of the connective portion 23 and the thickness of the connective portion 34. The aperture 26 can be in the form of a rectangular aperture of a length, width or diagonal length larger than the sum of the thickness of the connective portion 23 and the thickness of the connective portion 34. The aperture 26 can be in any other proper shape of a cross-sectional dimension larger the sum of the thickness of the connective portion 23 and the thickness of the connective portion 34. Thirdly, the width of the connective portion 23 is smaller than the width of the connective portion 34. In fact, the width of a portion of the handle 13 that extends along the rear edge is smaller than the width of a portion of the handle 13 that extends along the front edge.

The present invention has been described via the detailed illustration of two embodiments. Those skilled in the art can derive variations from the embodiments without departing from the scope of the present invention. Therefore, the embodiments shall not limit the scope of the present invention defined in the claims.

1. A self-cushioning hammer including:
a handle including a front edge, a rear edge, and a centerline L extending between the front and rear edges;
a head formed at an end of the handle; and
a cushioning mechanism formed on the handle, wherein the cushioning mechanism includes at least one cutout cut in one of the front and rear edges of the handle.

2. The self-cushioning hammer according to claim 1, wherein the cutout includes an open end, a closed end, and two walls each extending between the open and closed ends.

3. The self-cushioning hammer according to claim 2, wherein the open end of the cutout is located at one of the front and rear edges of while the closed end is located beyond the centerline L.

4. The self-cushioning hammer according to claim 2, wherein the open end of the cutout is made of a width smaller than that of the closed end.

5. The self-cushioning hammer according to claim 2, wherein the closed end of the cutout is a flat face.

6. The self-cushioning hammer according to claim 5, wherein the closed end of the cutout is separated from each of the walls by an acute angle θ.

7. The self-cushioning hammer according to claim 6, wherein the acute angle θ is 40° to 80°.

8. The self-cushioning hammer according to claim 1, wherein the cushioning mechanism includes a first cutout cut in the rear edge and a second cutout cut in the front edge.

9. The self-cushioning hammer according to claim 1, wherein the cushioning mechanism further includes an aperture made in the handle.

10. The self-cushioning hammer according to claim 9, wherein the aperture is a slot.

11. The self-cushioning hammer according to claim 10, wherein the handle includes two connective portions and, wherein the slot extends between the connective portions and, wherein the slot is made of a thickness larger than the sum of thicknesses of the connective portions and.

12. The self-cushioning hammer according to claim 1, wherein the front edge is wider than the rear edge.
